(19) United States
(12) Patent Application Publication
(10) Pub. No.: US 2004/0216565 A1
(43) Pub. Date: Nov. 4, 2004

(54) Pawl having at least two supporting protrusions for contacting inside of recess of ratchet wrench

(76) Inventor: Terence Chen, Ilan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/854,368

(22) Filed: May 27, 2004

Related U.S. Application Data
(63) Continuation-in-part of application No. 10/308,021, filed on Dec. 3, 2002.

(30) Foreign Application Priority Data
Nov. 11, 2002 (TW) 091218181

(51) Int. Cl. B25B 13/46

(52) U.S. Cl. 81/63.2

(57) ABSTRACT

A pawl of a ratchet tool includes two protrusions extending from a rear side thereof so as to contact the curve inside of the recess fro receiving the pawl of the wrench. A spring is biased between an end of the pawl and the inside of the recess. The curve inside of the recess applies two forces at different angles along the curve inside to the two protrusions of the pawl so as to push the pawl to match its driving teeth with the engaging teeth of the engaging wheel in the wrench. The multiple contact points between the pawl and the curve inside of the recess share the force so as to reduce damage of the pawl and the inside of the recess due to the stress concentration.

This is a Continuation-In-Part application of applicant's former patent application Ser. No. 10/308,021, filed on Dec. 3, 2002.

### FIELD OF THE INVENTION

### BACKGROUND OF THE INVENTION

A conventional ratchet wrench 90 is disclosed in FIGS. 6 and 7, and generally includes a head 91 and an engaging wheel 93 is rotatably received in a through hole 92 of the head 91. A recess 94 is defined in an inner periphery of the through hole 92 and a pawl 95 is movably received in the recess 94. The pawl 95 has teeth 950 which are engaged with teeth 930 defined in an outer periphery of the engaging wheel 93. A spring 96 has one end connected to an end of the pawl 95 and the other end of the spring 96 is fixed to an inside of the recess 94. Although the pawl 95 has a curve surface which is supposed to match with the curve inside of the recess 94, unfortunately, only one contact point 97 between the curve surface and the curve inside. The force “F” fully applies to the contact point 97 and results in stress concentration at that contact point 97 such that the curve inside and/or the curve surface tends to be damaged. If the contact point 97 is located close to an end of the curve surface of the pawl 95 as shown in FIG. 6, the teeth 950 on the other end of the pawl 95 could slightly off contact with the teeth 930 of the engaging wheel 93. If the contact point 97 is located at a center of the curve surface of the pawl 95 as shown in FIG. 7, the pawl 95 is not in a stable status and could shake during operation. Accordingly, only limited number of teeth 950 is matched with the teeth 930 of the engaging wheel 93. This means the limited number of teeth 930 could be broken and cannot output a large torque which is a desired result for the tool.

U.S. Pat. No. 6,647,832 discloses a protrusion extending from the curve inside of the recess so as to contact the pawl. Nevertheless, there is only one contact point at the an end of rear side of the pawl and the curve inside of the recess. The shortcoming mentioned above is not overcome. The protrusion only push the pawl toward the engaging wheel and does not include any support feature. The force is concentrated at the contact point between the rear side of the pawl and the curve inside of the recess.

The present invention intends to provide a pawl which has at lest two protrusions on its rear side so as to form at least two support points to dispense the force between the pawl and the inside of the recess. The pawl increase the effective number of matched teeth between the pawl and the engaging wheel so as to provide a high output torque and to prolong the term of use.

### SUMMARY OF THE INVENTION

The present invention relates to a ratchet wrench which comprises an engaging wheel rotatably received in a through hole in the head of the wrench and having engaging teeth on outer periphery thereof. A pawl is movably received in a recess defined in an inner periphery of the through hole and has driving teeth in a front side thereof so as to match with the engaging teeth. At least two protrusions extend from a rear curve surface of the pawl so as to contact against the curve inside of the recess. A spring is biased between an end of the pawl and the inside of the recess. The at least two protrusions provide prevent stress concentration at only one contact point as disclosed in the conventional pawl. The reaction forces corresponding to the two contact points ensure more number of the driving teeth is effectively matched with the engaging teeth.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the ratchet wrench of the present invention;

FIG. 2 is a perspective view to show the ratchet wrench of the present invention;

FIG. 3 shows the arrangement of the pawl and the recess in the head of the ratchet wrench of the scooter of the present invention;

FIG. 4 is an enlarged view to show the two protrusions of the pawl contacting the inside of the recess and two reaction forces push the pawl toward the engaging wheel;

FIG. 5 shows the driving teeth of the pawl are disengaged from the engaging teeth of the engaging wheel and the convex portion on the pawl contacts the inside of the recess;

FIG. 6 shows the only contact point is located at the rear side and close to an end of the conventional pawl, and

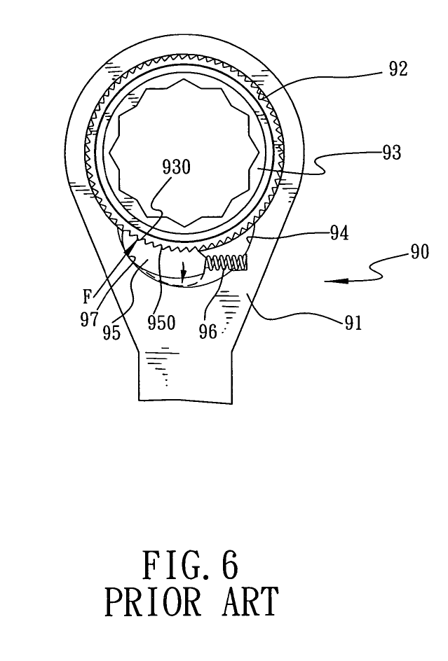

FIG. 7 shows the only contact point is located at a center of the rear side and close to an end of the conventional pawl.

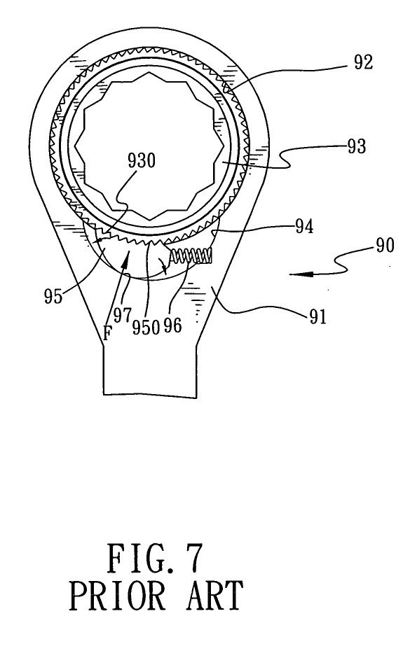

### DETAILED DESCRIPTION OF THE PREFERRED EMBODIMENT

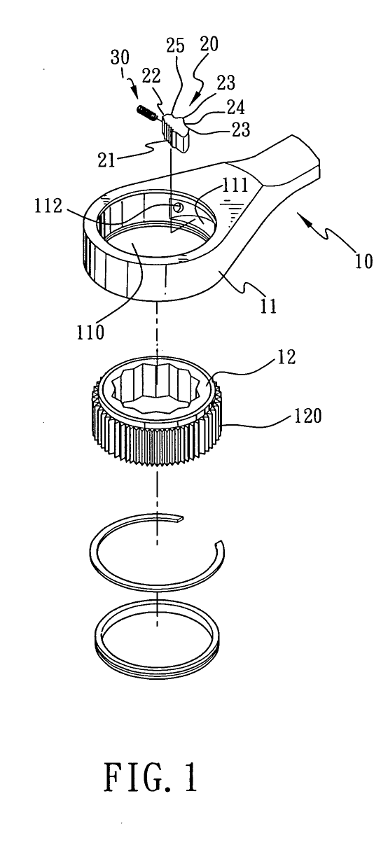

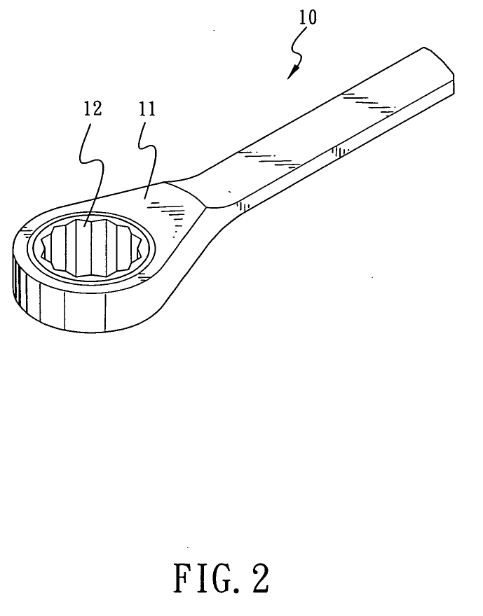

Referring to FIGS. 1 to 3, the ratchet wrench 10 of the present invention comprises a head 11 having a through hole 110 and a recess 111 is defined in an inner periphery of the through hole 110. The recess 111 is defined by a curve inside. An engaging wheel 12 is rotatably received in the through hole 110 and has engaging teeth 120 defined in an outer periphery thereof.

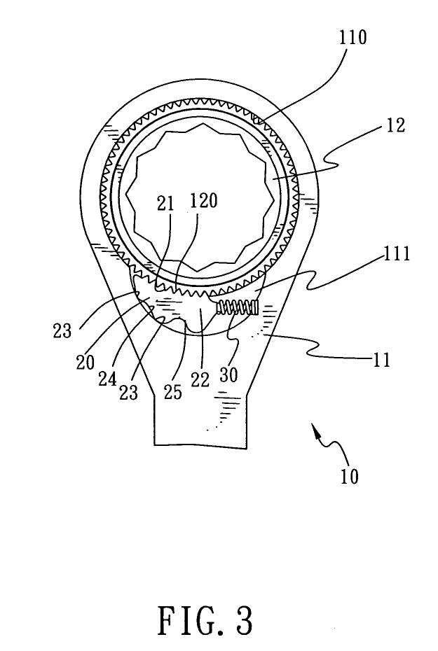

A pawl 20 is movably received in the recess 111 and has driving teeth 21 defined in a front side thereof so as to be engaged with the engaging teeth 120 of the engaging wheel 12. Two protrusions 23 extend from a rear side of the pawl 20 and contact the curve inside of the recess 111 when the pawl 20 is in operation position as shown in FIG. 3. A concavity 24 is defined between the two protrusions 23. The number of the protrusions 23 can be more than two if necessary.

A biasing member 30 such as a spring has a first end connected to a positioning portion 22 at an end of the pawl 20 and a second end of the biasing member 30 is engaged with a hole 112 defined in the curve inside of the recess 111. The pawl 20 has a convex portion 22 extending from the rear side thereof and located close to the positioning portion 22 of the pawl 20.

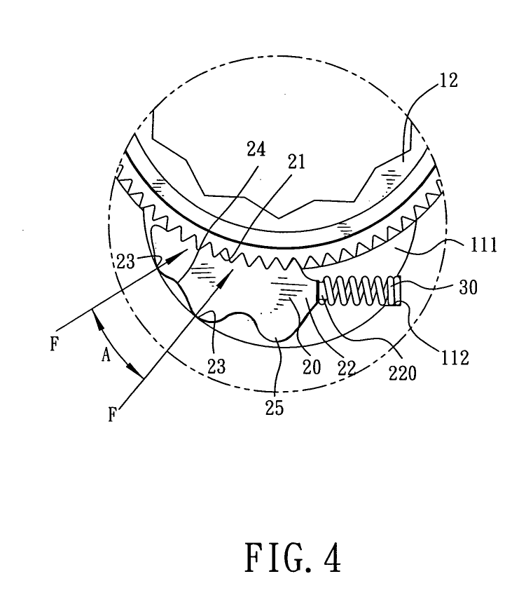

As shown in FIG. 4, when the pawl 20 is in its operation position, the driving teeth 21 are matched with the engaging teeth 120, and the two protrusions 23 are in contact with the curve inside of the recess 111. The curve inside of the recess 111 applies two reaction forces “F” with an angle “A” clamped therebetween to the two protrusions 23 and push the driving teeth 21 of the pawl 20 to match with the engaging teeth 120. The two protrusions 23 share the forces “F” so that neither the curve inside of the recess 111 nor the pawl 20 is to be damaged because of stress concentration. The two forces “F” at different angles also increase the number of the driving teeth 21 that are effectively engaged with the engaging teeth 120 so that the driving teeth 21 and the engaging teeth 120 may have a longer life of use.

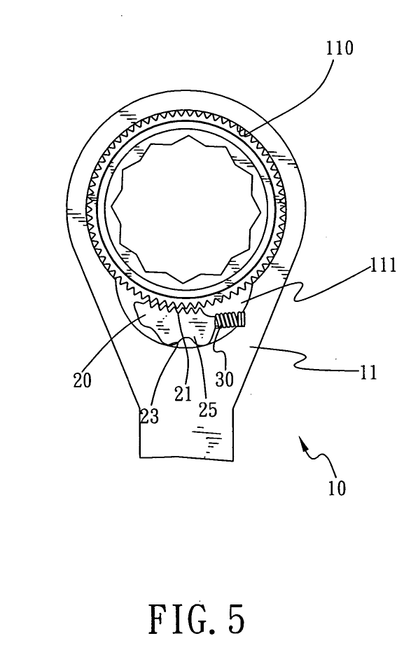

As shown in FIG. 5, when the pawl 20 is disengaged from the engaging wheel 12, the convex portion 25 contacts the curve inside of the recess 111 and ensures all the driving teeth 21 are separated from the engaging teeth 120.

While we have shown and described the embodiment in accordance with the present invention, it should be clear to those skilled in the art that further embodiments may be made without departing from the scope of the present invention.

What is claimed is:

1. A pawl of a ratchet wrench (10) wherein the pawl (20) has driving teeth (21) defined in a front side thereof and at least two protrusions (23) extend form a rear end of the pawl (20), the wrench (10) have a recess (111) defined in a head of the wrench (10) and the recess (111) defined by a curve inside, the at least two protrusions (23) contact the curve inside of the recess (111).

2. A ratchet wrench (10) comprising:
a head (11) having a through hole (110) and a recess (111) defined in an inner periphery of the through hole (110), the recess (111) defined by a curve inside, an engaging wheel (12) rotatably received in the through hole (110) and having engaging teeth (120) defined in an outer periphery thereof;
a pawl (20) movably received in the recess (111) and having driving teeth (21) defined in a front side thereof, the driving teeth (21) engaged with the engaging teeth (120) of the engaging wheel (12), at least two protrusions (23) extending from a rear side of the pawl (20) and contacting the curve inside of the recess (111), and
a biasing member (30) having a first end connected to an end of the pawl (20) and a second end of the biasing member (30) engaged with a hole (112) defined in the curve inside of the recess (111).

3. The wrench as claimed in claim 2, wherein a concavity (24) is defined between the at least two protrusions (23).

4. The wrench as claimed in claim 2, wherein the pawl (95) includes a positioning portion (22) at the end of the pawl (20) so as to be connected to the first end of the biasing member (30).

5. The wrench as claimed in claim 2, wherein the biasing member (30) is a spring (30).

6. The wrench as claimed in claim 2, wherein the pawl (20) has a convex portion (22) extending from the rear side thereof and close to the end connecting the biasing member (30).
